(19) United States
(12) Patent Application Publication
(10) Pub. No.: US 2017/0106726 A1
(43) Pub. Date: Apr. 20, 2017

(54) DUAL CIRCUIT TRANSPORTATION REFRIGERATION SYSTEM

(71) Applicant: Carrier Corporation, Jupiter, FL (US)

(72) Inventors: Mary D. Saroka, Syracuse, NY (US); Robert A. Chopko, Baldwinsville, NY (US); Jeffrey J. Burchill, Baldwinsville, NY (US)

(21) Appl. No.: 15/316,879

(22) PCT Filed: Jun. 30, 2015
(86) PCT No.: PCT/US2015/038544

§ 371 Date: Dec. 7, 2016

Related U.S. Application Data
(60) Provisional application No. 62/019,014, filed on Jun. 30, 2014.

(51) Int. Cl. B60H 1/32

(52) U.S. Cl. CPC B60H 1/3226; B60H 1/323; B60H 1/3205; B60H 2001/327; B60H 2001/3292; B60H 2001/3282; B60H 2001/3277

(57) ABSTRACT

A refrigeration system for a refrigerated cargo container includes two or more refrigeration circuits, each circuit configured to cool a compartment of the refrigerated cargo container. Each circuit includes a compressor (38) to compress a gaseous flow of refrigerant, a gas cooler (40) in fluid communication with the compressor to cool the compressed flow of refrigerant, and an evaporator (46) located at the compartment and in fluid communication with the gas cooler and the compressor. An electrical generator (34) is operably connected to the compressor of each circuit to drive the compressors and a control system operably connected to the electrical generator and the two or more circuits. The control system is configured to calculate a maximum electrical power generated by the generator, calculate a target electrical load of the components of each circuit, and distribute the available electrical power from the generator to meet the target electrical load of each circuit.

### BACKGROUND

The subject matter disclosed herein relates to refrigeration systems. More particularly, the present disclosure relates to transportation refrigeration systems.

Recently passed legislation is driving the transportation refrigeration industry, including refrigeration units for trucks, trailers, cargo containers, rail systems, and the like, toward developing products utilizing low global warming potential (GWP) refrigerants. With this come efforts to improve control of the system so that the cargo is maintained at a selected temperature to reduce adverse effects on the cargo such as spoilage or rot.

### BRIEF SUMMARY

In one embodiment, a refrigeration system for a refrigerated cargo container includes two or more refrigeration circuits, each refrigeration circuit configured to cool a compartment of the refrigerated cargo container. Each refrigeration circuit includes a compressor to compress a gaseous flow of refrigerant, a gas cooler in fluid communication with the compressor to cool the compressed flow of refrigerant, and an evaporator located at the compartment and in fluid communication with the gas cooler and the compressor. An electrical generator is operably connected to the compressor of each refrigeration circuit to drive the compressors and a control system operably connected to the electrical generator and the two or more refrigeration circuits. The control system is configured to calculate a maximum electrical power generated by the generator, calculate a target electrical load of the components of each refrigeration circuit, and distribute the available electrical power from the generator to meet the target electrical load of each refrigeration circuit.

Additionally or alternatively, in this or other embodiments the target electrical load for each refrigeration circuit is based on a temperature set point of each refrigeration circuit.

Additionally or alternatively, in this or other embodiments the electrical generator is powered by a diesel engine.

Additionally or alternatively, in this or other embodiments the refrigerant is a CO₂ refrigerant.

Additionally or alternatively, in this or other embodiments a first refrigeration circuit of the two or more refrigeration circuits utilizes a first refrigerant and a second refrigeration circuit of the two or more refrigeration circuits utilizes a second refrigerant different from the first refrigerant.

Additionally or alternatively, in this or other embodiments the compressor is a multi-stage compressor.

Additionally or alternatively, in this or other embodiments the refrigeration circuit is configured to compress a flow of refrigerant at a first stage of the compressor, convey the flow of refrigerant from the compressor through the gas cooler to undergo thermal energy exchange, return the flow of refrigerant to the compressor from the gas cooler; compress the flow of refrigerant at a second stage of the compressor, and flow the refrigerant through the gas cooler a second time to undergo further thermal energy exchange.

Additionally or alternatively, in this or other embodiments a flash tank is located along the refrigeration circuit fluidly between the gas cooler and the evaporator to separate residual gaseous refrigerant from the flow of refrigerant.

Additionally or alternatively, in this or other embodiments an electrically powered evaporator fan is located at the evaporator to induce a flow of air across the evaporator.

Additionally or alternatively, in this or other embodiments an electrically powered gas cooler fan is located at the gas cooler to induce a flow of air across the gas cooler.

In another embodiment, a refrigerated cargo container includes a container having a plurality of walls to define an enclosure, with two or more compartments defined in the container. A refrigeration system is operably connected to the container to provide cooling to the two or more compartments. The refrigeration system includes two or more refrigeration circuits, each refrigeration circuit configured to cool a compartment of the two or more compartments. Each refrigeration circuit includes a compressor to compress a gaseous flow of refrigerant, a gas cooler in fluid communication with the compressor to cool the compressed flow of refrigerant, and an evaporator located at the compartment and in fluid communication with the gas cooler and the compressor. An electrical generator is operably connected to the compressor of each refrigeration circuit to drive the compressors, and a control system is operably connected to the electrical generator and the two or more refrigeration circuits. The control system is configured to calculate a maximum electrical power generated by the generator, calculate a target electrical load of the components of each refrigeration circuit, and distribute the available electrical power from the generator to meet the target electrical load of each refrigeration circuit.

Additionally or alternatively, in this or other embodiments the target electrical load for each refrigeration circuit is based on a temperature set point of each compartment.

Additionally or alternatively, in this or other embodiments a first temperature set point of a first compartment of the two or more compartments differs from a second temperature set point of a second compartment of the two or more compartments.

Additionally or alternatively, in this or other embodiments the electrical generator is powered by a diesel engine.

Additionally or alternatively, in this or other embodiments the refrigerant is a CO₂ refrigerant.

Additionally or alternatively, in this or other embodiments the compressor is a multi-stage compressor.

Additionally or alternatively, in this or other embodiments the refrigeration circuit is configured to compress a flow of refrigerant at a first stage of the compressor, convey the flow of refrigerant from the compressor through the gas cooler to undergo thermal energy exchange, return the flow of refrigerant to the compressor from the gas cooler, compress the flow of refrigerant at a second stage of the compressor, and flow the refrigerant through the gas cooler a second time to undergo further thermal energy exchange.

Additionally or alternatively, in this or other embodiments a flash tank is positioned along the refrigeration circuit fluidly between the gas cooler and the evaporator to separate residual gaseous refrigerant from the flow of refrigerant.

Additionally or alternatively, in this or other embodiments an electrically powered evaporator fan is located at the evaporator to induce a flow of air across the evaporator.

Additionally or alternatively, in this or other embodiments an electrically powered gas cooler fan is located at the gas cooler to induce a flow of air across the gas cooler.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a perspective view of an embodiment of a refrigerated cargo container with multiple compartments;

FIG. 2 is a plan view of another embodiment of a refrigerated cargo compartment with multiple compartments;

FIG. 3 is a schematic view of a refrigeration system for a refrigerated cargo container having multiple refrigeration circuits; and

FIG. 4 is a perspective view of an embodiment of a refrigeration system for a refrigerated cargo container.

### DETAILED DESCRIPTION

With reference to the drawings in the appendix filed herewith, the system and method disclosed herein are utilized in a transportation refrigeration unit for refrigeration of a truck, trailer, cargo container or the like, hereinafter referred to as a “container”.

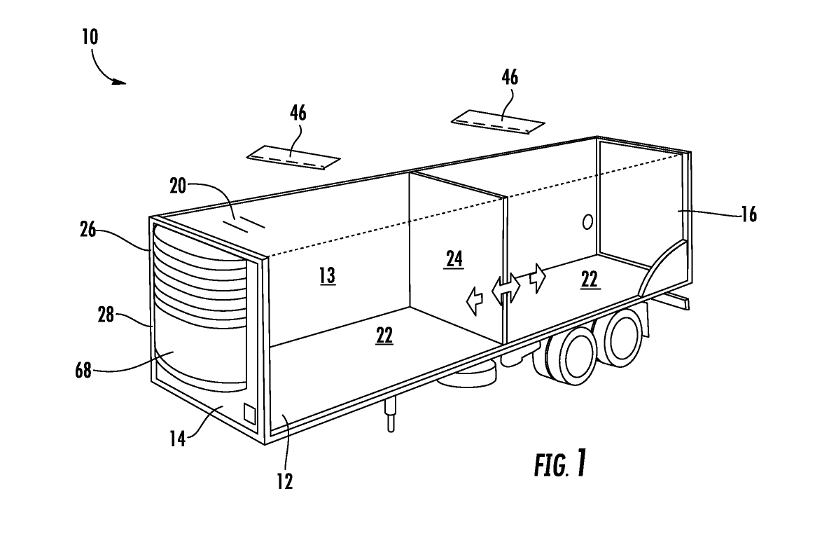

Referring to FIG. 1, a container 10 is generally a rectangular prism in shape, including a floor 12, a first or front wall 14, and a second or rear wall 16 opposite the front wall 14. The container 10 further includes opposing sidewalls 18 and a top wall 20 to enclose the volume. The sidewalls 18 and/or the rear wall 16 may include one or more doors or openings (not shown) through which cargo is loaded into and/or unloaded from the container 10.

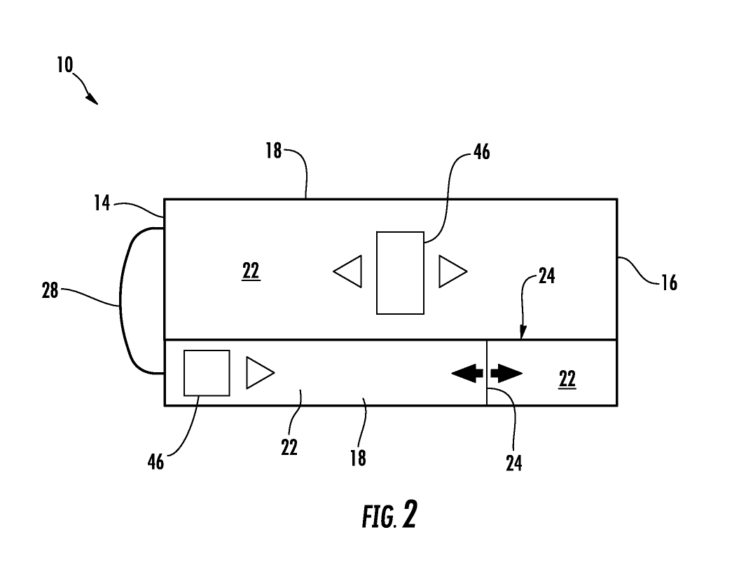

The container 10 is divided into multiple compartments 22, via arrangement of one or more interior walls 24. As shown in FIG. 1, the compartments 22 may be arranged lengthwise in the container 10, or alternatively as shown in FIG. 2, may be arranged side-by-side or some combination of lengthwise and side-by-side. One skilled in the art will readily appreciate that other arrangements of compartments 22 may be utilized, depending on the placement of interior walls 24. For example, compartments 22 may be arranged on top of one another. Often the compartments 22 are utilized to allow for maintaining cargo or goods in the compartments 22 at different temperatures based on storage needs of the cargo.

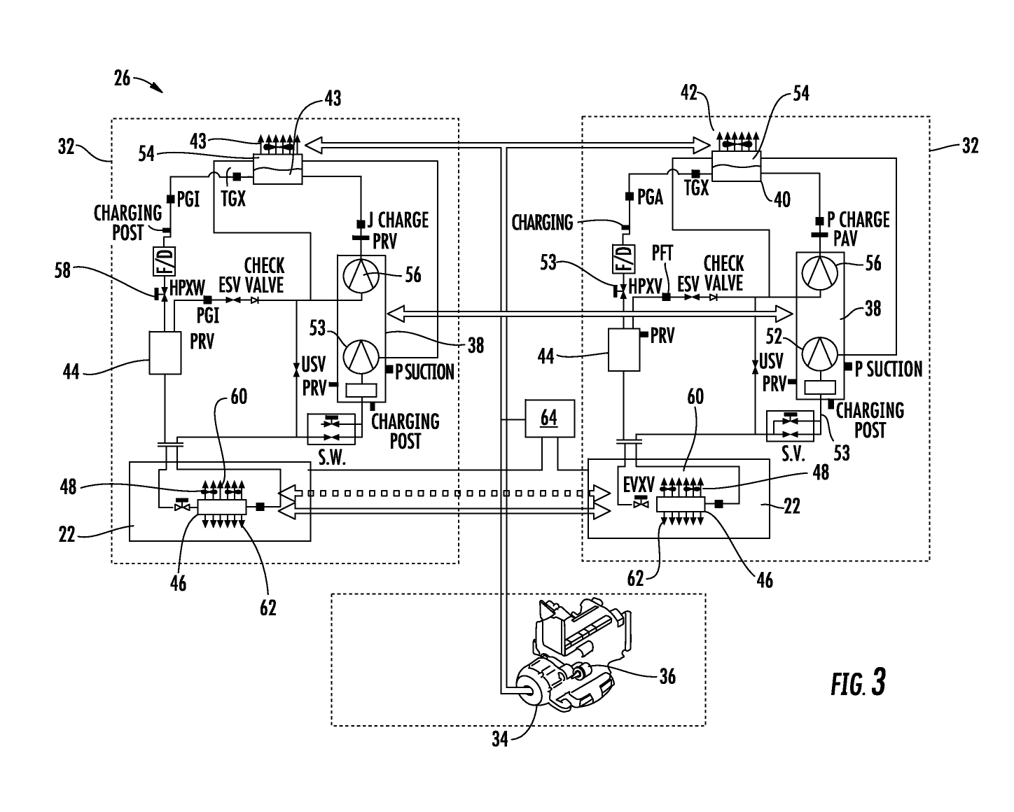

Referring again to FIG. 1, the container 10 includes a refrigeration system 26 including a transportation refrigeration unit 28 located, for example, at the front wall 14 with remote evaporators 46 connected to the refrigeration unit 28, located at each compartment 22. A schematic of a refrigeration system 26 is shown in FIG. 3. The refrigeration system 26 of FIG. 3 includes two refrigeration circuits 32, with each refrigeration circuit 32 providing cooling to one or more compartments 22. It is to be appreciated that for containers 10 having more than two compartments 22, a refrigeration system 26 with additional refrigeration circuits 32 may be utilized, for example three or four refrigeration circuits 32. In some embodiments, each refrigeration circuit 32 utilizes a low global warming potential (GWP) and/or natural refrigerant such as CO₂. One skilled in the art will readily appreciate that other refrigerants, such as conventional R-134a refrigerant, may be utilized. Further, in some embodiments, the refrigeration circuits 32 do not include the same refrigerant, with selected refrigeration circuits 32 including different refrigerants. For example, one refrigeration circuit 32 may utilize CO₂, while another refrigeration circuit 32 may utilize R-134a.

The refrigeration system 26 is powered by a generator 34, which is in turn driven by a prime mover such as a diesel engine 36. The refrigeration circuits 32 of the refrigeration system 26 may be substantially identical, and as such one refrigeration circuit 32 will be described herein with the understanding that additional refrigeration circuits 32 have substantially identical structures.

A compressor 38 is operably connected to the generator 34 and driven by the generator 34. In some embodiments, such as shown in FIG. 3, the compressor 38 is a multi-stage, variable speed compressor 38. It is to be appreciated that other compressor configurations may be utilized. The refrigeration circuit 32 includes a gas cooler 40 with an electrically powered gas cooler fan 42, which is powered by the generator 34, a flash tank 44 and an evaporator 46 including an evaporator fan 48 powered by the generator 34. In some embodiments, the evaporator 46 and evaporator fan 48 are located remotely at the compartment 22 to be cooled by the refrigeration circuit 32.

In operation, a flow of refrigerant 50 enters the compressor 38 and is compressed via a first stage 52 of the compressor 38. Compressed first stage refrigerant exits the compressor 38 as a high pressure gas and is conveyed to an intercooler 54 of gas cooler 40. From the intercooler 54, the flow of refrigerant is conveyed back to the compressor 38 and is further compressed at a second stage 56 of the compressor 38. From the second stage 56, the compressed second stage refrigerant exits the compressor 38 and is conveyed to the gas cooler 40. At the gas cooler 40, a thermal energy exchange between the compressed second stage refrigerant, the compressed first stage refrigerant and ambient air urged across the gas cooler 40 by the gas cooler fan 42 results in the flow of refrigerant 50 exiting the gas cooler 40 as a reduced temperature, high pressure vapor.

From the gas cooler 40 the flow of refrigerant 50 proceeds through an expansion valve 58 and enters the flash tank 44 as a low pressure liquid. At the flash tank 44 any residual gaseous refrigerant in the flow of refrigerant 50 is separated out and directed back to the compressor 38. Liquid refrigerant in the flow of refrigerant 50 is urged from the flash tank 44 to the evaporator 46 where the evaporator fan 48 directs a flow of return air 60 across the evaporator 46. After thermal exchange between the return air 60 and the flow of refrigerant 50 at the evaporator 46, newly cooled airflow, now referred to as supply air 62 flows into the compartment 22 to cool the compartment 22 and the cargo therein. The flow of refrigerant 50 is then returned to the compressor 38, is particular the first stage 52.

In some embodiments, a gas cooler coil wraps around the gas cooler fan 42, increasing a heat-transfer surface area for greater efficiency in a configuration that is both compact and lightweight. The resulting refrigeration circuit 32 is versatile in responding to the thermodynamic properties of CO₂, providing gas cooling after each compression stage for improved efficiency. The flash tank 44 is configured to manage a flow and phase change of the flow of refrigerant 50 after leaving the gas cooler 40. For efficient cooling performance, the configuration enables separation of remaining gaseous CO₂ from liquid CO₂ before entering the evaporator 46.

A control system 64 is utilized to control operation of the diesel engine 36 and generator 34 as well as the compressors 38, gas cooler fans 42 and evaporator fans 48. The control system calculates a maximum electrical power generated by the diesel engine 36 and generator 34 and also calculates a target electrical load of the components (compressor 38, gas cooler fan 42, evaporator fan 48) for each refrigeration circuit 32 based on, for example, a temperature set point of each refrigeration circuit 32. The control system 64 distributes the available electrical power from the generator 34 to meet the target electrical load of each refrigeration circuit 32. Component controls such as variable speed, a compressor economizer and/or unloader are utilized to determine and implement a balanced power control.

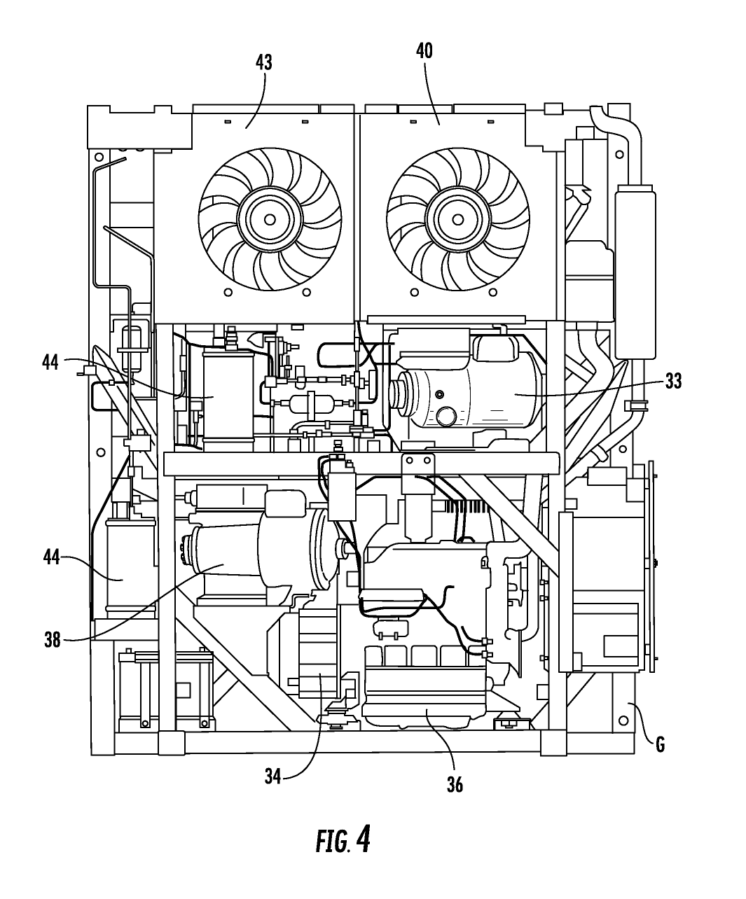

Referring now to FIG. 4, the components of refrigeration circuits 32 (compressor 38, gas cooler 40, gas cooler fan 42) and also the diesel engine 36 and generator 34 are located at in secured in a frame 66. The configuration allows for compact packaging of the components in the frame 66, which in some embodiments is located at the front wall 14 and which is, as shown in FIG. 1, enclosed by a cover 68.

Benefits of the present disclosure include, but are not limited to, operation of a refrigeration system using an environmentally friendly natural refrigerant of CO₂. Individualized refrigeration control of each compartment as opposed to typical multi-compartment utilizing a single refrigeration circuit with a single compressor, which must meet the needs of all compartments while utilizing the same compressor suction setting. Further, the present system provides improved control of each refrigeration circuit based on individual compartment refrigeration requirements. The present system provides for at least partial load loss protection. In a typical multi-temperature container system, if the compressor fails, temperature control is lost in all compartments, while a compressor failure in the present system would result in the loss of temperature control in only one compartment, leaving other refrigeration circuits associated with other compartments to function normally.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A refrigeration system for a refrigerated cargo container comprising:
two or more refrigeration circuits, each refrigeration circuit configured to cool a compartment of the refrigerated cargo container and including:
a compressor to compress a gaseous flow of refrigerant;
a gas cooler in fluid communication with the compressor to cool the compressed flow of refrigerant; and
an evaporator located at the compartment and in fluid communication with the gas cooler and the compressor;
an electrical generator operably connected to the compressor of each refrigeration circuit to drive the compressors; and
a control system operably connected to the electrical generator and the two or more refrigeration circuits and configured to:
calculate a maximum electrical power generated by the generator;
calculate a target electrical load of the components of each refrigeration circuit; and
distribute the available electrical power from the generator to meet the target electrical load of each refrigeration circuit.

2. The refrigeration system of claim 1, wherein the target electrical load for each refrigeration circuit is based on a temperature set point of each refrigeration circuit.

3. The refrigeration system of claim 1,
wherein the electrical generator is powered by a diesel engine.

4. The refrigeration system of claim 1, wherein the refrigerant is a CO₂ refrigerant.

5. The refrigeration system of claim 1, wherein a first refrigeration circuit of the two or more refrigeration circuits utilizes a first refrigerant and a second refrigeration circuit of the two or more refrigeration circuits utilizes a second refrigerant different from the first refrigerant.

6. The refrigeration system of claim 1, wherein the compressor is a multi-stage compressor.

7. The refrigeration system of claim 6, wherein the refrigeration circuit is configured to:
compress a flow of refrigerant at a first stage of the compressor;
convey the flow of refrigerant from the compressor through the gas cooler to undergo thermal energy exchange;
return the flow of refrigerant to the compressor from the gas cooler;
compress the flow of refrigerant at a second stage of the compressor; and
flow the refrigerant through the gas cooler a second time to undergo further thermal energy exchange.

8. The refrigeration system of claim 1, further comprising a flash tank disposed along the refrigeration circuit fluidly between the gas cooler and the evaporator to separate residual gaseous refrigerant from the flow of refrigerant.

9. The refrigeration system of claim 1, further comprising an electrically powered evaporator fan disposed at the evaporator to induce a flow of air across the evaporator.

10. The refrigeration system of claim 1, further comprising an electrically powered gas cooler fan disposed at the gas cooler to induce a flow of air across the gas cooler.

11. A refrigerated cargo container comprising:
a container having a plurality of walls to define an enclosure, with two or more compartments defined in the container;
a refrigeration system operably connected to the container to provide cooling to the two or more compartments, the refrigeration system including:
two or more refrigeration circuits, each refrigeration circuit configured to cool a compartment of the two or more compartments and including:
a compressor to compress a gaseous flow of refrigerant;
a gas cooler in fluid communication with the compressor to cool the compressed flow of refrigerant; and
an evaporator located at the compartment and in fluid communication with the gas cooler and the compressor;
an electrical generator operably connected to the compressor of each refrigeration circuit to drive the compressors; and
a control system operably connected to the electrical generator and the two or more refrigeration circuits and configured to:
calculate a maximum electrical power generated by the generator;
calculate a target electrical load of the components of each refrigeration circuit; and
distribute the available electrical power from the generator to meet the target electrical load of each refrigeration circuit.

12. The refrigerated cargo container of claim 11, wherein the target electrical load for each refrigeration circuit is based on a temperature set point of each compartment.

13. The refrigerated cargo container of claim 12, wherein a first temperature set point of a first compartment of the two or more compartments differs from a second temperature set point of a second compartment of the two or more compartments.

14. The refrigerated cargo container of claim 11, wherein the electrical generator is powered by a diesel engine.

15. The refrigerated cargo container of claim 11, wherein the refrigerant is a CO₂ refrigerant.

16. The refrigerated cargo container of claim 11, wherein the compressor is a multi-stage compressor.

17. The refrigerated cargo container of claim 16, wherein the refrigeration circuit is configured to:
compress a flow of refrigerant at a first stage of the compressor;
convey the flow of refrigerant from the compressor through the gas cooler to undergo thermal energy exchange;
return the flow of refrigerant to the compressor from the gas cooler;
compress the flow of refrigerant at a second stage of the compressor; and
flow the refrigerant through the gas cooler a second time to undergo further thermal energy exchange.

18. The refrigerated cargo container of claim 11, further comprising a flash tank disposed along the refrigeration circuit fluidly between the gas cooler and the evaporator to separate residual gaseous refrigerant from the flow of refrigerant.

19. The refrigerated cargo container of claim 11, further comprising an electrically powered evaporator fan disposed at the evaporator to induce a flow of air across the evaporator.

20. The refrigerated cargo container of claim 11, further comprising an electrically powered gas cooler fan disposed at the gas cooler to induce a flow of air across the gas cooler.
